(19) United States
(12) Patent Application Publication
(10) Pub. No.: US 2006/0039577 A1
(43) Pub. Date: Feb. 23, 2006

(54) Method and apparatus for wireless communication using an inductive interface

(76) Inventors: Jorge Sanguino, Minneapolis, MN (US); Randall W. Roberts, Eden Prairie, MN (US)

Correspondence Address: Schwegman, Lundberg, Woessner & Kluth, P.A., P.O. Box 2938, Minneapolis, MN, 55402, US

(21) Appl. No.: 11/207,555

(22) Filed: Aug. 18, 2005

Related U.S. Application Data
(60) Provisional application No. 60/602,381, filed on Aug. 18, 2004.

(51) Int. Cl. H04R 25/00

(52) U.S. Cl. 381/315; 381/312

(57) ABSTRACT

A system including a hearing assistance device sized for fitting a human ear, and adapted to communicate with a wireless transceiver. The wireless transceiver enables the hearing assistance device to communicate with other wireless devices. In varying embodiments, the hearing assistance device works with a near field communication network. By using the hearing assistance device to communicate with wireless transceiver, which can also communicate with a remote device, the hearing assistance device becomes more compatible with, for instance, a cellular telephone, by disabling redundant speakers and microphones, and by transmitting voice data.

### CLAIM OF BENEFIT

This application claims the benefit of U.S. Provisional Patent Application Ser. No. 60/602,381, filed Aug. 18, 2004, which is hereby incorporated by reference in its entirety.

### TECHNICAL FIELD

This application relates generally to wireless communications for hearing assistance devices, and more particularly to method and apparatus for wireless communication between a hearing assistance device with an inductive interface and a remote device.

### BACKGROUND

Portable self-powered hearing assistance devices have been developed to provide sound conditioning. A popular use for hearing assistance devices is to provide assistance for hearing impairment. Such devices are highly programmable and compact. However, difficulties in configuring other devices to provide communications to such devices are common. There is a need in the art for improved communications systems to enable communications between other devices and hearing assistance devices. Such systems should be adapted retrofit existing components and should employ existing standards where possible.

### SUMMARY

The above-mentioned problems and others not expressly discussed herein are addressed by the present subject matter and will be understood by reading and studying this specification.

The present subject matter includes an apparatus and method for communication involving a hearing assistance device having a first antenna and a remote wireless device, comprising a first wireless circuit adapted for connection to a second antenna to conduct inductive communications with the first antenna; a second wireless circuit adapted for radio frequency communications; a controller in communication with the first wireless circuit and the second wireless circuit; a microphone in communication with the controller; and a power source to provide power to the apparatus.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their legal equivalents.

### BRIEF DESCRIPTION OF THE DRAWINGS

Various embodiments are illustrated by way of example in the figures of the accompanying drawings.

FIG. 1 illustrates a perspective view of a hearing assistance device and a wireless transceiver, according to one embodiment of the present subject matter.

FIG. 2. illustrates a side view of a wireless communication system, according to one embodiment of the present subject matter.

FIG. 3 illustrates a block diagrams for a wireless transceiver and hearing aid, according to one embodiment of the present subject matter.

FIG. 4 illustrates a block diagrams for a wireless transceiver and hearing aid, according to one embodiment of the present subject matter.

FIG. 5A illustrates a perspective view of one embodiment of a wireless communications adapter, according to one embodiment of the present subject matter.

FIG. 5B illustrates a perspective view of one embodiment of a wireless communications adapter, according to one embodiment of the present subject matter.

FIG. 6A is a cross sectional view of one embodiment of a wireless communications adapter, according to one embodiment of the present subject matter.

FIG. 6B is a cross sectional view of one embodiment of a wireless communications adapter, according to one embodiment of the present subject matter.

FIG. 7A is a cross sectional view of one embodiment of a charger for a wireless communications adapter, according to one embodiment of the present subject matter.

FIG. 7B is a cross sectional view of one embodiment of a charger for a wireless communications adapter, according to one embodiment of the present subject matter.

FIG. 8 illustrates a flowchart for operation of a wireless transceiver used to relay wireless communication, according to one embodiment of the present subject matter.

FIG. 9 shows a front view of one example of a wireless communications adapter according to one embodiment of the present subject matter.

FIG. 10 shows a back view of one example of a wireless communications adapter according to one embodiment of the present subject matter.

FIG. 11 shows a top view of one example of a wireless communications adapter according to one embodiment of the present subject matter.

FIG. 12 shows a bottom view of one example of a wireless communications adapter according to one embodiment of the present subject matter.

FIG. 13 shows a first side view of one example of a wireless communications adapter according to one embodiment of the present subject matter.

FIG. 14 shows a second side view of one example of a wireless communications adapter according to one embodiment of the present subject matter.

FIG. 15 is a perspective view of a wireless communications adapter and a dock, according to one embodiment of the present subject matter.

FIG. 16 is a perspective view of a wireless communications adapter and a dock, according to one embodiment of the present subject matter.

FIG. 17 is a perspective view of a wireless communications adapter and a dock, according to one embodiment of the present subject matter.

FIG. 18 is a schematic of a wireless communications adapter and an antenna, according to one embodiment of the present subject matter.

### DETAILED DESCRIPTION

The following detailed description of the present invention refers to subject matter in the accompanying drawings which show, by way of illustration, specific aspects and embodiments in which the present subject matter may be practiced. These embodiments are described in sufficient detail to enable those skilled in the art to practice the present subject matter. It will be apparent, however, to one skilled in the art that the various embodiments may be practiced without some of these specific details. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

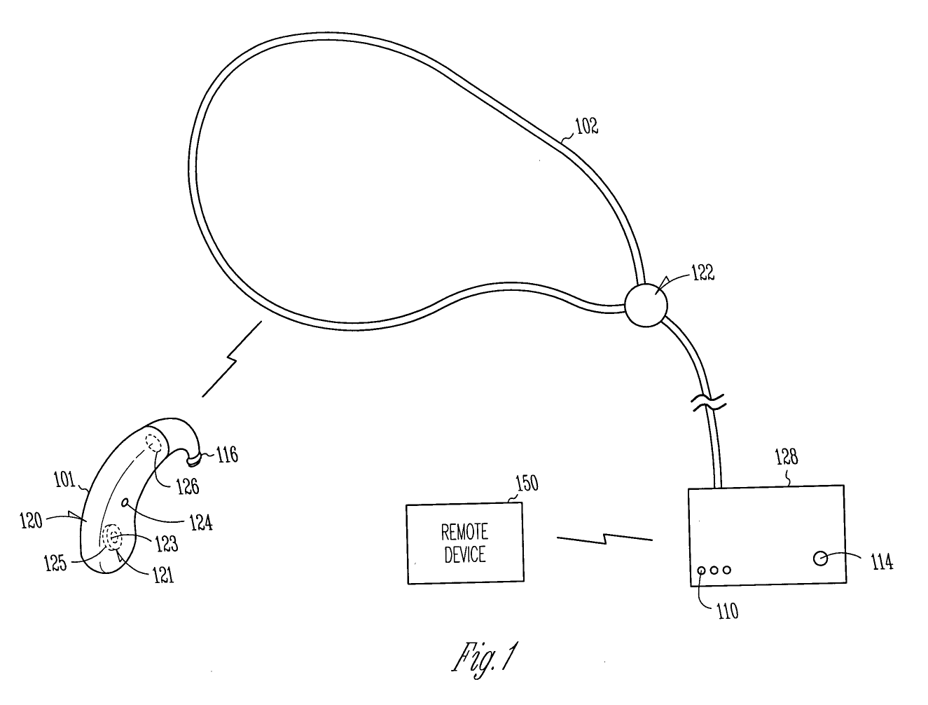

FIG. 1 illustrates a perspective view of a hearing assistance device 120, a wireless transceiver 122, and a remote device 150, according to one embodiment of the present subject matter. A hearing assistance device 120 includes a hearing aid housing 101 sized for use with a human ear. In some examples, the hearing aid housing 101 includes hearing aid electronics, a hearing aid speaker 126, a hearing aid port 116 for transmitting sound to an earpiece, a hearing assistance device microphone 124 and a hearing assistance device connector. Although the shape of the pictured housing 101 resembles what is termed a “behind-the-ear” design, the present subject matter extends to any hearing assistance device, including those with other shapes. An example remote device is a cellular telephone, but the present subject matter extends to any remote device adapted for communications compatible with the wireless transceiver.

The pictured hearing assistance device 120 includes a hidden view of a near field antenna 121 adapted for inductive communications. Varying designs of such an antenna include, but are not limited to, a core 123 around which is wrapped a conductor 125, forming an inductive antenna. Some inductive coil designs adhere to telecoil communication standards.

The present subject matter, in varying embodiments, provides a system for interfacing with a telecoil of a hearing assistance device to provide wireless communications. In providing such function, the present subject matter enables wireless communication using various protocols. Such embodiments include unidirectional and bidirectional communication modes. Some unidirectional embodiments require only a transmitter and receiver to conduct unidirectional communications. For example, the wireless transceiver is able to communicate unidirectionally to a hearing assistance device when the hearing assistance device includes only a receiver.

In some embodiments, the system is adapted for communications with a remote device. Some embodiments are adapted for far field communications to a remote device. Various embodiments use communications compatible with the BLUETOOTH wireless protocol standard. For example, in one embodiment, the remote device 150 is any device adapted for BLUETOOTH compatible communications. Such devices can provide full duplex communications, in various embodiments. Such devices include cell phones, computers, and other devices having a BLUETOOTH transceiver. In various examples, a cellular telephone is adapted to communicate in networks compatible with a BLUETOOTH protocol. In some of these examples, embodiments using a 2.4 GHz signal are possible. Some embodiments compatible with a class 2 BLUETOOTH headset standard are additionally within the present scope.

In various embodiments, wireless transceiver 122 includes a neck loop 102 with a pendant 128. The present subject matter includes neck loop 102 designs which are integrated with an antenna adapted to communicate with the near field antenna 121 of a hearing assistance device. Various forms of data can be communicated. For example, data such as voice data, streaming audio data, application data, and/or functional parameters, may be communicated with such a configuration. Other forms of data may be communicated without departing from the scope of the present subject matter.

In various embodiments, pendant 128 is a single piece. In various embodiments, pendant 128 includes a dock for receiving a wireless communications adapter. Some embodiments package an antenna used for inductive coil communications with a hearing assistance device in the dock, and package electronics for wireless communications with a remote device in a wireless communications adapter. Some designs of a wireless communications adapter are provided in copending U.S. patent application Ser. No. ______ filed even date herewith entitled WIRELESS COMMUNICATIONS ADAPTER FOR A HEARING ASSISTANCE DEVICE (Attorney Docket No. 1346.039US1) and U.S. Provisional Patent Application Ser. No. 60/602,496, filed Aug. 18, 2004, both of which are incorporated by reference in their entirety. More details on one example of a dock system are provided below.

Embodiments having a pendant 128 are useful as users can position the device around their neck without limiting their normal activities. The pendant can operate independent of non-voice signal notification to a user, but some embodiments communicate information to the user using visual indicators 110, or other types of indicators.

In varying embodiments, an additional microphone can be added to the system. In some embodiments, a microphone 114 is located in pendant 182. Such embodiments enable the wireless communication system to optionally deactivate the hearing assistance device microphone 124.

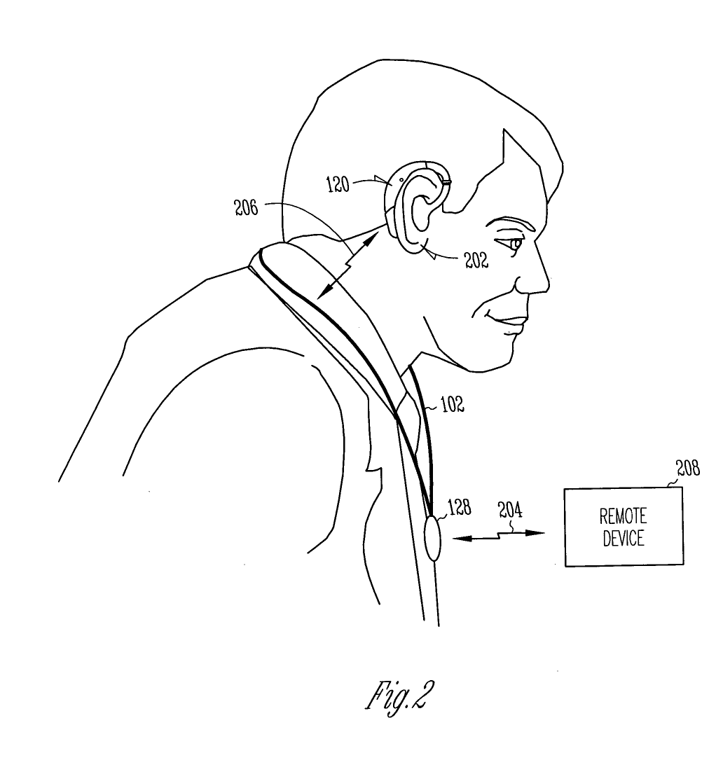

FIG. 2 illustrates a side view of a wireless communication system, according to one embodiment of the present subject matter. In various embodiments, the figure illustrates the hearing assistance device 120 worn by an individual, and further illustrates a wireless transceiver worn by an individual, the wireless transceiver having a pendant 128 and a neck loop 102. In varying embodiments, the hearing assistance device 120 is a BTE (behind-the-ear) hearing aid worn behind the ear 202. The hearing assistance device 120 and the wireless transceiver communicate wirelessly 206, in various embodiments, through transmissions performed using neck loop antenna 102.

The hearing assistance device 120 and wireless transceiver can communicate information 204 to a remote device. In one embodiment, wireless communication 206 represents a near field or inductive network, and wireless communication 204 represents a radio frequency or far field network. In some embodiments, the far field communications are performed using the BLUETOOTH protocol. Additionally, in some embodiments, the remote device 208 is a cellular telephone capable of operating on a BLUETOOTH compatible wireless network. Other protocols and other far field devices are possible without departing from the scope of the present subject matter. Additionally, in various embodiments, the wireless transceiver is capable of far-field network communications with more than one remote device, either in sequence or concurrently.

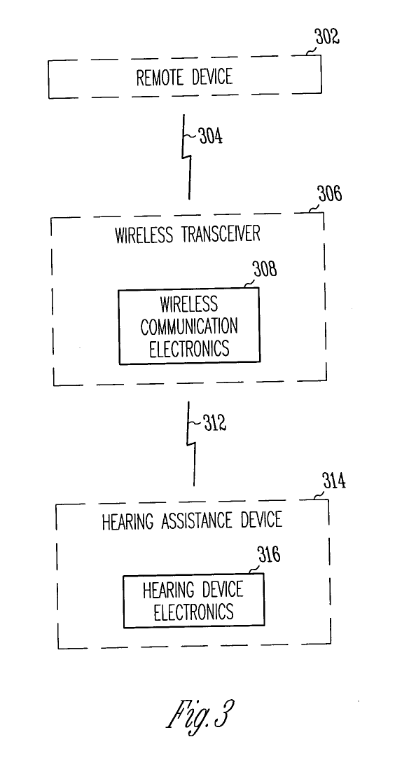

FIG. 3 illustrates a block diagram for a wireless transceiver 306 and hearing assistance device 314, according to one embodiment of the present subject matter. In varying embodiments, the system includes a hearing assistance device 314 performing near field communication 312 with a wireless transceiver 306. The near field communication 312 between the wireless transceiver 306 and the hearing assistance device 314 relay voice data in varying embodiments. In additional embodiments, other forms of data, such as control data, streaming audio, parameters, and programs may be communicated using near field communications 312. In varying examples, the hearing assistance device 314 includes hearing assistance device electronics 316 which enable communications and which include components which use these communications. For example, in some embodiments, the hearing assistance device electronics include a memory to store programs and parameters. Additional embodiments include a controller to process information and to create non-voice information for the wireless transceiver.

The wireless transceiver 306 includes, in some embodiments, wireless communication electronics 308 adapted for producing far field wireless communications 304 with a remote device 302. These wireless communication electronics 308, in various embodiments, additionally provide near field communications 216 with additional devices, such as hearing assistance device 314.

Various embodiments provide far-field communications 304 carrying digital signals. Some of these embodiments include encoded verbal data. Additional embodiments include encoded non-verbal data. In various examples, the wireless communication electronics 308 are adapted to communication in a manner compatible with the BLUETOOTH communication standard. Although a single remote device 302 is illustrated, multiple remote devices may be used with the present subject matter. Multiple remote devices may be used concurrently or sequentially.

FIG. 4 illustrates a block diagram for a wireless transceiver 402 and a hearing assistance device 430, according to one embodiment of the present subject matter. In varying embodiments, the wireless transceiver 402 includes a controller 404 which is adapted to control varying components within the wireless transceiver 402. In various embodiments, controller 404 facilitates interoperability of the wireless communications components.

Various embodiments of the present subject matter include a system in which a hearing assistance device 430 is adapted for communicating 426 with the wireless transceiver 402. In varying embodiments, the hearing assistance device communicates 426 with the inductive coil 420 of the wireless transceiver 402. In one embodiment, the wireless transceiver is adapted for telecoil communications 426 with a hearing assistance device 430. In various embodiments, inductive coil antenna 420 is suited for near field communication through an inductive loop antenna. In one embodiment, the inductive loop antenna is shaped like a necklace.

Various embodiments of the present subject matter include a wireless transceiver 402 capable of communications with a remote device. In some embodiments, wireless transceiver 402 is capable of far-field communications with a remote device. Some embodiments communicate with a remote device using a communication regime compatible with the BLUETOOTH standard of wireless communication. Such embodiments communicate with a remote device using and antenna 414. In some embodiments, the antenna 414 is connected to a wireless communication subcomponent 410. Wireless transceiver 402 includes additional components in various embodiments. Some embodiments include a power source 406. The power source, in varying embodiments, is a battery, such as a Lithium-ion Polymer battery. Some embodiments communicate power remaining. For example, some embodiments include a multi-colored LED which indicates power levels. Additional embodiments include a volume control 408.

Additionally, varying embodiments include indicators 412 representing other functional states. One example includes a multi-color LED which indicates that the wireless communication subcomponent 410 is powered on and is prepared for communication. The present subject matter includes several functional embodiments, and in one embodiment a powered on wireless communication subcomponents 410 enables the wireless transceiver 402 to pair with a remote device. In various embodiments, a multi-color LED additionally indicates successful paring. Various embodiments indicate these functions during operation on a network compatible with the BLUETOOTH communication protocol.

Some designs within the present subject matter construct network relationships between a remote device and wireless transceiver 402 which resemble master-slave relationships. For example, one embodiment includes a master device and a slave device, and functions such that the master device serves to awake the slave device in instances where communication occurs. In varying designs, pairing is facilitated by a button located on one or both of the remote device and/or the wireless transceiver 402. In one example, a button 422 is located on the wireless transceiver to perform this function.

Information such as volume, pairing, and other information, can be stored in a memory 416. In varying embodiments, the memory is useful to store operational parameters, such as volume and status. In varying embodiments, the memory 416 is useful for storing application data. Application data may include processing instructions, communications instructions, and multimedia processing instructions. Other forms of data additionally are stored in memory 416.

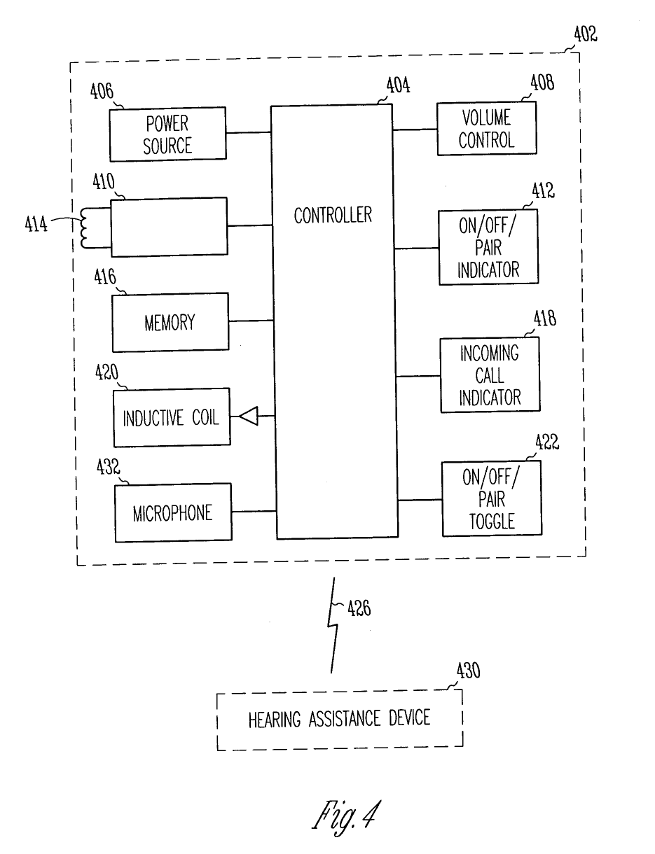

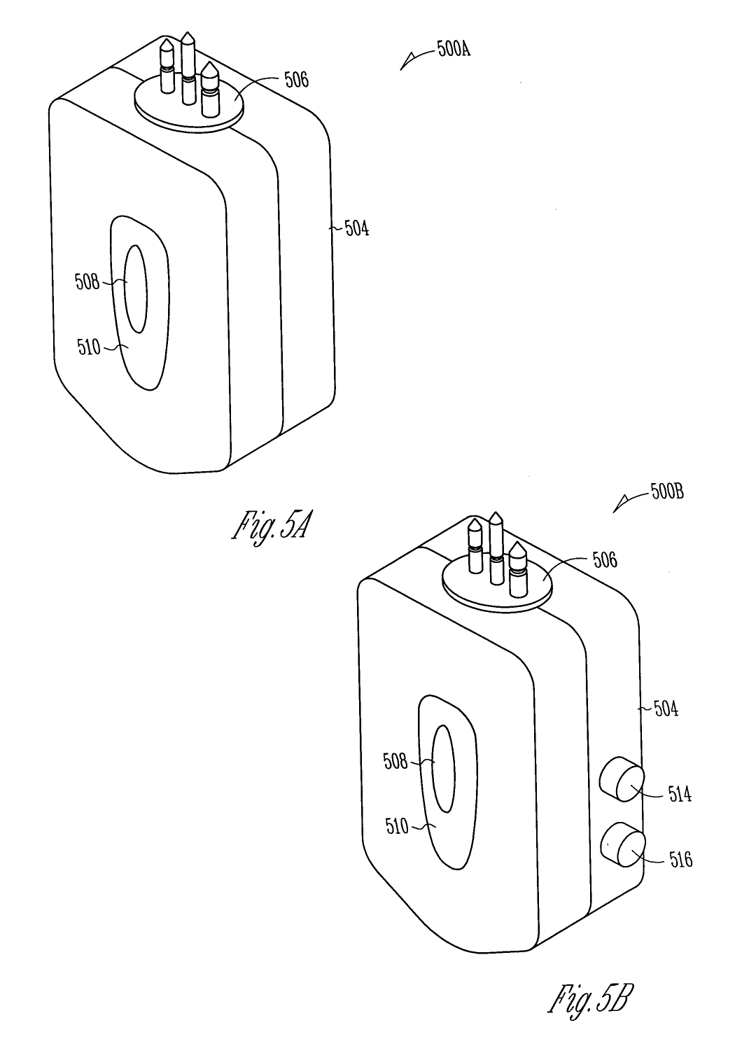

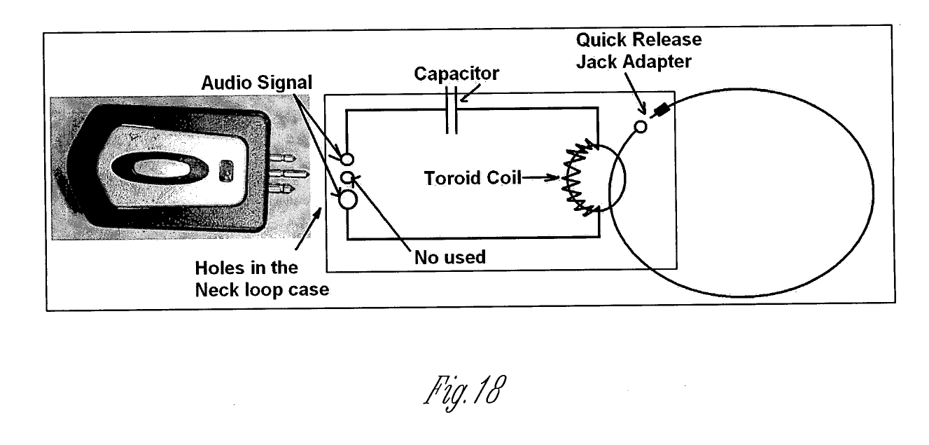

The present subject matter also contemplates a dock having an antenna for magnetic field communications that is driven by a wireless communications adapter, such as the example shown in FIGS. 17 and 18. FIG. 5A illustrates a perspective view of one embodiment of a wireless communications adapter, according to one embodiment of the present subject matter. In one embodiment, the wireless communications adapter 500A includes a DAI connector 506. In some embodiments, the connector 506 may be adjustable so that it can swivel to position the wireless communications adapter 500A at different angles to the device connected to connector 506. In various embodiments, the wireless communication adapter 500A includes a housing 504 including one or more buttons 510 to perform functions. The wireless communication adapter 500A, in various embodiments, also includes one or more indicators 508 to indicate aspects of the operation of the device. Placement and types of buttons and indicators may vary without departing from the scope of the present subject matter. FIG. 5B illustrates another variation of a wireless communications adapter 500B including the aspects set forth for wireless communications adapter 500A and including an optional volume control 514 and an optional power port 516. The position and types of volume control 514 and power port 516 may vary without departing from the scope of the present subject matter.

Thus, the wireless communications adapter may be embodied in several designs having varying form factors and features without departing from the scope of the present subject matter.

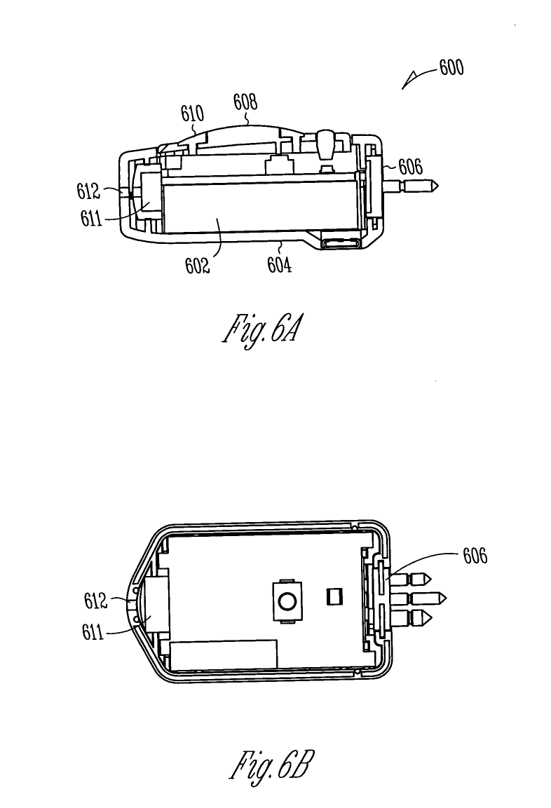

FIG. 6A is a cross sectional view of one embodiment of a wireless communications adapter, according to one embodiment of the present subject matter. The cross section of wireless communications adapter 600 shown in FIG. 6A provides housing 604 for housing a battery 602 and a microphone 611. The microphone hole 612 allows sound to reach the microphone 611. Indicator 608 is optionally connected to button 610 which is accommodated by housing 604. Connector 606 is also accommodated by housing 604. Other electronics can be included within the housing as exemplified by FIG. 3B. FIG. 6B is another cross sectional view of one embodiment of a wireless communications adapter, according to one embodiment of the present subject matter. FIG. 6B shows placement of microphone 611, microphone hole 612, and connector 606 according to one embodiment of the present subject matter. Other configurations and shapes and subcomponents are possible without departing from the scope of the present subject matter. Some embodiments may exist which do not include a microphone. Although a DAI connector is demonstrated, it is understood that other connectors can be employed in various embodiments of the present subject matter.

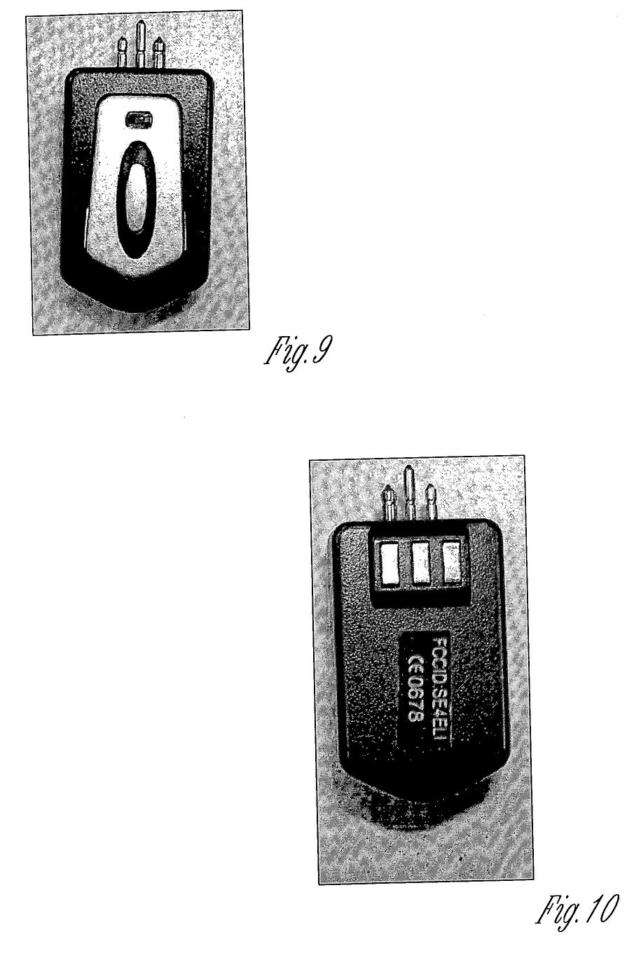

In various embodiments of the present wireless communications adapter, the battery is rechargeable. In such embodiments, the wireless communications adapter can include contacts for charging. One example of such contacts are shown in FIG. 9. In some embodiments, the wireless communications adapter includes an optional charging port. Other arrangements are possible for charging which are within the scope of the present subject matter.

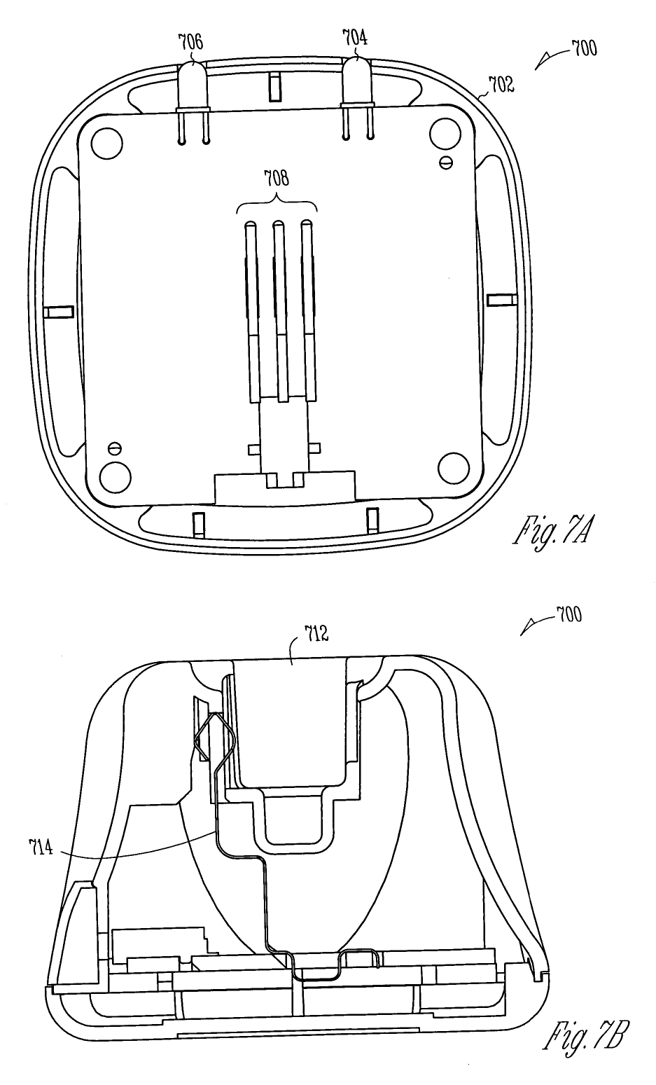

FIG. 7A is a cross sectional view of one embodiment of a charger for a wireless communications adapter, according to one embodiment of the present subject matter. Charger 700 includes LEDs 704 and 706 to indicate status concerning the charging of the device. Contacts 708 receive power for charging from a power supply. One approach is the use of a transformer and wall plugin which is fed to the charger 700. FIG. 7B is a cross sectional view of one embodiment of a charger for a wireless communications adapter, according to one embodiment of the present subject matter. Contacts 714 are adapted to receive current from a power source plugged into charger 700 and provide them to a device inserted into opening 712 which as adapted to receive the device and bias contacts of the device against the contacts 714. Other configurations are possible without departing from the scope of the present subject matter.

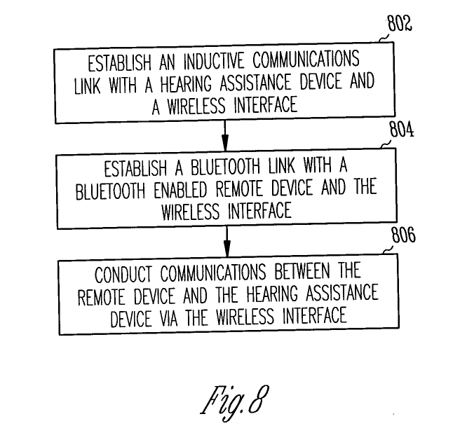

FIG. 8 is a flowchart for operation of a wireless transceiver used for wireless communication, according to one embodiment of the present subject matter. An inductive communications link is established 802 between the hearing assistance device and the wireless interface. A far field link is established 804 with a remote device and the wireless interface. In some of these embodiments, the far field link includes a wireless protocol which is compatible with the BLUETOOTH communication standard. Communications between the wireless interface and the remote device and the wireless interface and the hearing assistance device are conducted 806. Such communications may take on varying communication protocols, and at varying rates. For instance, the inductive link may communicate analog information between a hearing assistance device and the wireless transceiver, but the far field link may be conducting digital communications with a remote device using a protocol compatible with the BLUETOOTH communication standard. Various combinations and types of protocols fall within the present subject matter.

FIG. 9 is a front view of a wireless communications adapter, according to one embodiment of the present subject matter. The illustration shows a button, an indicator light, and connector for connecting the wireless communications adapter to additional components, such as a neck-worn antenna loop having a dock adapted to receive the wireless communications adapter.

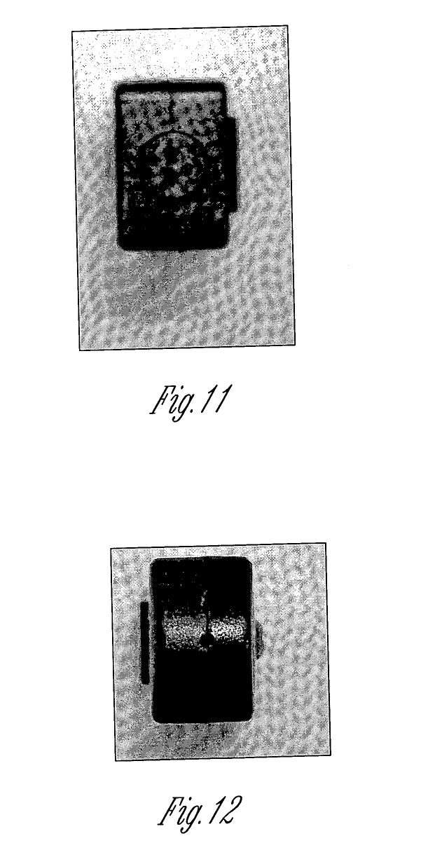

FIG. 10 is a back view of a wireless communications adapter, according to one embodiment of the present subject matter. The illustration shows a wireless communications adapter having three conductive pads adapted for multiple connections to a charger. Other arrangements are possible without departing from the scope of the present subject matter.

FIG. 11 is a bottom view of a wireless communications adapter, according to one embodiment of the present subject matter. The illustration shows a connector adapted for interface with other devices, such as a neck-worn antenna loop having a dock adapted to receive the wireless communications adapter. One example of such a connector is compatible with a direct audio input (DAI) connector.

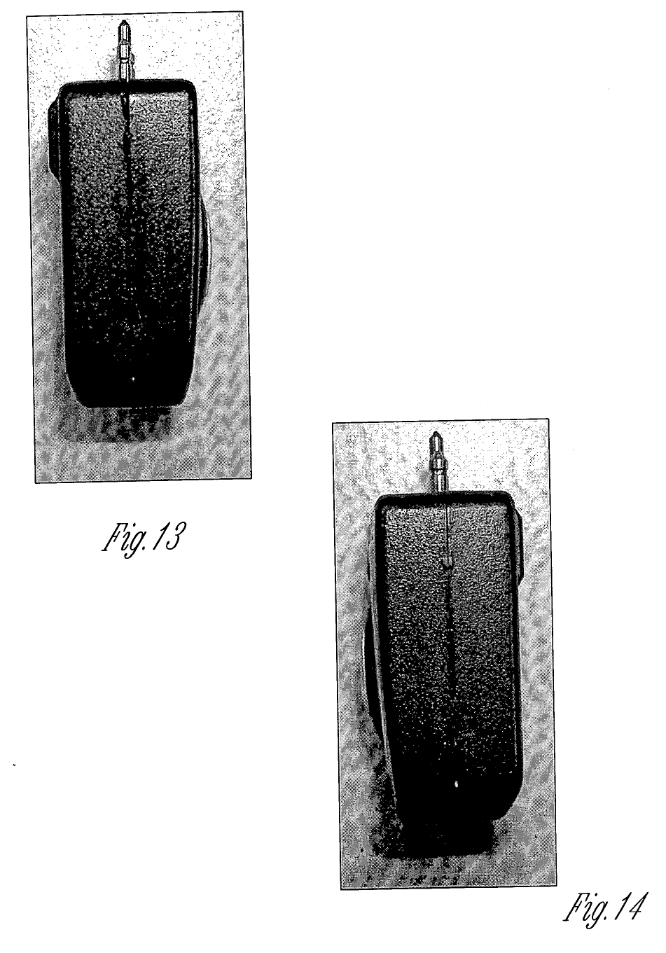

FIG. 12 is a top view of a wireless communications adapter, according to one embodiment of the present subject matter. The illustration shows a port suited for sound communication, in various embodiments. Such a port may be coupled to a microphone which is housed in the wireless communications adapter. This microphone may be used instead of the microphone of a hearing assistance device. The hearing assistance device is set in a telecoil operational mode to receive the inductive signals. Many telecoil modes will deactivate the microphone of the hearing assistance device. In such cases the microphone of the wireless communications adapter can be used to hear local sound. It is also possible to transmit the received sound to the remote device. Many configurations and uses are possible without departing from the scope of the present subject matter.

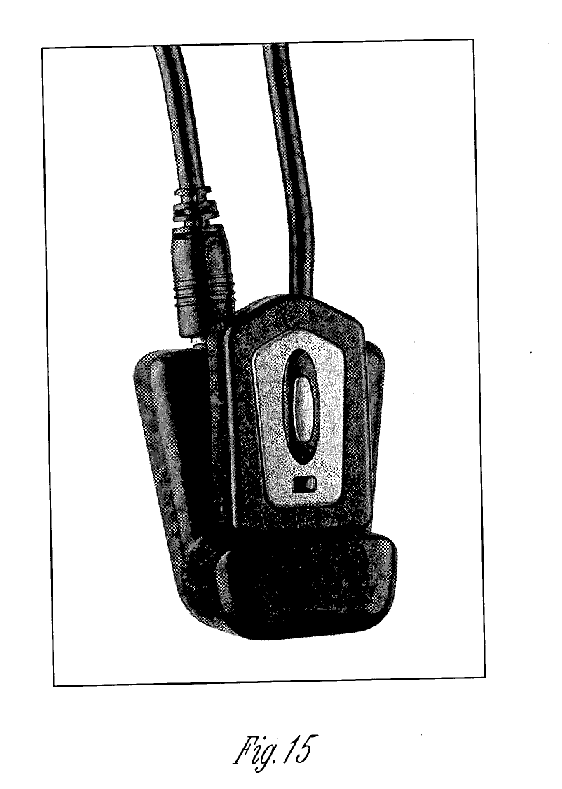

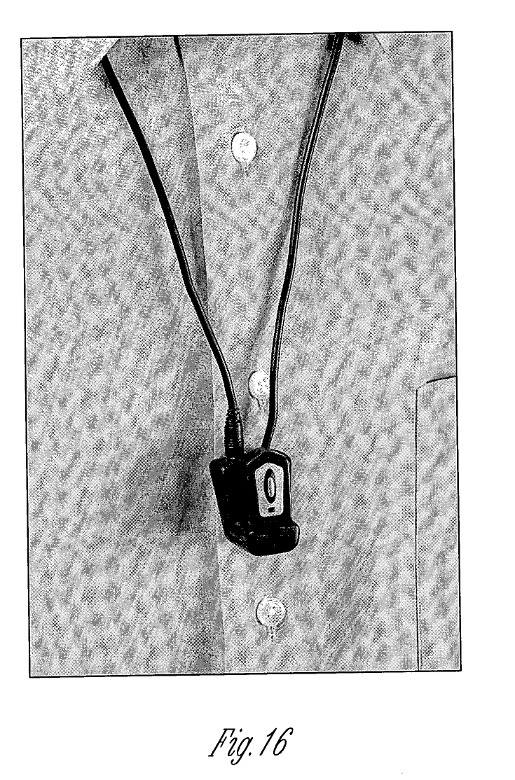

FIGS. 13-14 show side views of a wireless communications adapter, according to one embodiment of the present subject matter.

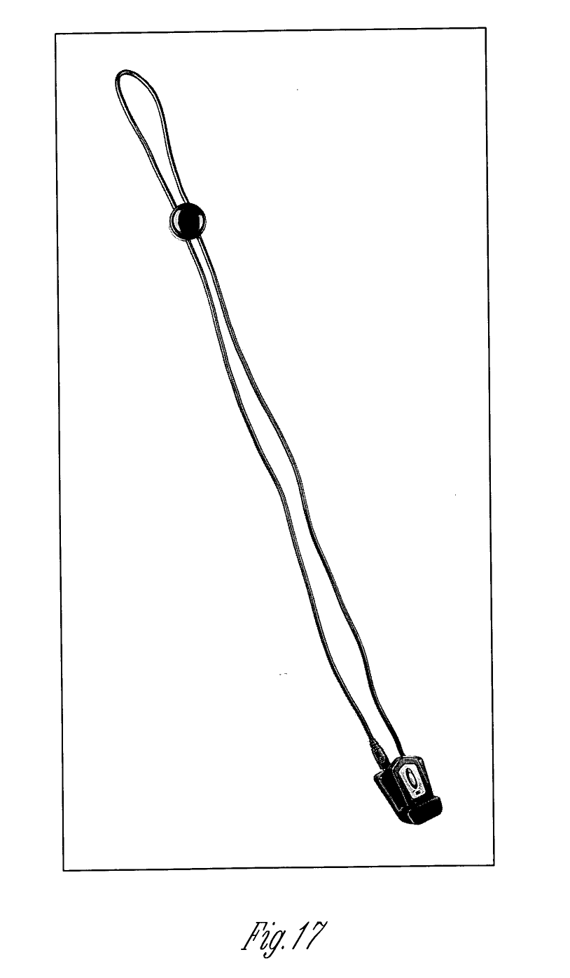

FIGS. 15-16 show perspective views of a wireless communications adapter and a dock, according to one embodiment of the present subject matter. The dock provides for connection to the wireless communications adapter, and also provides a neck loop shaped like a necklace and suitable for wear around the neck. In various embodiments, the wireless communications adapter does not have an antenna for communication with a hearing assistance device, but instead relies on an antenna of the dock. For example, in various embodiments, the dock is attached a neck loop antenna.

In various embodiments, the neck loop is formed by connecting one end of an extended cord, which is integrated at one end with the dock, to a connection point in the connection dock. The illustration shows a connector connected to the pendant, with the connector having various stress relief provisions to decrease damage occurring due to repeated bending.

FIG. 17 is a perspective view of a wireless communications adapter and a dock, according to one embodiment of the present subject matter. The illustration shows a slidable adjustment button which controls, in part, the size of the neck loop portion which circumscribes a user's neck.

FIG. 18 is a schematic of a wireless communications adapter and an antenna, according to one embodiment of the present subject matter. In various embodiments, the present subject matter disposes an antenna in a pendant dock worn around the neck. A wireless communications adapter of the present subject matter is connected to that pendant dock so that it can communicate with a hearing assistance device using an antenna. The pendant dock includes a neck loop having a connector. In one embodiment, the connector is a quick release jack adapter. The pendant dock additionally includes a toroidal coil, a capacitor. These components enable inductive coil communications with a hearing assistance device, according to various embodiments of the present subject matter. Antenna signals, such as audio signals, are communicated to the wireless communications adapter through a connection port. Such a connection port is positioned in the pendant dock. For example, in various embodiments, the pendant dock includes hole in its case.

One of ordinary skill in the art will understand that, the systems shown and described herein can be implemented using software, hardware, and combinations of software and hardware. As such, the term “system” is intended to encompass software implementations, hardware implementations, and software and hardware implementations.

Although specific embodiments have been illustrated and described herein, it will be appreciated by those of ordinary skill in the art that any arrangement which is calculated to achieve the same purpose may be substituted for the specific embodiment shown. This application is intended to cover adaptations or variations of the present subject matter. It is to be understood that the above description is intended to be illustrative, and not restrictive. Combinations of the above embodiments, and other embodiments will be apparent to those of skill in the art after studying and understanding the above description. The scope of the present subject matter should be determined with reference to the appended claims, along with the full scope of equivalents to which such claims are entitled.

What is claimed is:

1. An apparatus for communication involving a hearing assistance device having a first antenna and a remote wireless device, comprising:
a first wireless circuit adapted for connection to a second antenna to conduct inductive communications with the first antenna;
a second wireless circuit adapted for radio frequency communications;
a controller in communication with the first wireless circuit and the second wireless circuit;
a microphone in communication with the controller; and
a power source to provide power to the apparatus.

2. The apparatus of claim 1, comprising a direct audio input connector adapted for connection to the second antenna.

3. The apparatus of claim 1, wherein the radio frequency communications are compatible with BLUETOOTH.

4. The apparatus of claim 1, wherein the second antenna is a loop antenna.

5. The apparatus of claim 1, further comprising a button adapted to control radio frequency communications.

6. The apparatus of claim 1, further comprising a radio frequency communications indicator connected to the second wireless circuit.

7. The apparatus of claim 1, wherein the apparatus is adapted to conduct unidirectional communications from the hearing assistance device.

8. The apparatus of claim 1, wherein the apparatus is adapted to conduct unidirectional communications to the hearing assistance device.

9. The apparatus of claim 1, wherein the apparatus is adapted to conduct bidirectional communications.

10. The apparatus of claim 1, wherein the apparatus is further adapted to removably connect to a dock.

11. The apparatus of claim 10, wherein the dock includes a loop antenna.

12. The apparatus of claim 11, wherein the loop antenna is integrated with the dock at a first end, and is connected to the dock at a removable connector at a second end.

13. The apparatus of claim 1, including a switch adapted for answering a telephone call.

14. The apparatus of claim 1, including a switch adapted for terminating a wireless connection to the remote wireless device.

15. The apparatus of claim 1, including a switch adapted for pairing the apparatus to the remote device.

16. An apparatus for communication involving a hearing assistance device having a first antenna and a remote wireless device, comprising:
a first wireless circuit adapted for connection to a second antenna to conduct inductive communications with the first antenna;
a second wireless circuit adapted for radio frequency communications according to a BLUETOOTH protocol;
a controller in communication with the first wireless circuit and the second wireless circuit;
a microphone in communication with the controller; and
a power source to provide power to the apparatus.

17. The apparatus of claim 17 adapted to for conducting wireless communications with a telephone.

18. A method for assisting user communications from a hearing assistance device having a first antenna to a remote wireless device, the method comprising:
communicating using inductive communications from the hearing assistance device to a wireless transceiver, the wireless transceiver having a power source and an inductive loop antenna; and
communicating radio frequency communications from the wireless transceiver to the remote wireless device.

19. The method of claim 18, further comprising communicating to a telephone as the remote device.

20. The method of claim 18, further comprising answering a telephone call.
